(19) United States
(12) Patent Application Publication
(10) Pub. No.: US 2021/0198522 A1
(43) Pub. Date: Jul. 1, 2021

(54) WATER-BASED COATING MATERIAL AND METHOD FOR MANUFACTURING THE SAME

(71) Applicant: INDUSTRIAL TECHNOLOGY RESEARCH INSTITUTE, Hsinchu (TW)

(72) Inventors: Kai-Wei LIAO, Taoyuan City (TW); Wei-Cheng TANG, Hsinchu City (TW); Ya-Tin YU, New Taipei City (TW); Yun-Shan HUANG, Zhunan Township (TW); Yeu-Kuen WEI, Hsinchu City (TW); Cheng-Yang TSAI, Taipei City (TW); Yi-Che SU, Zhubei City (TW)

(73) Assignee: INDUSTRIAL TECHNOLOGY RESEARCH INSTITUTE, Hsinchu (TW)

(21) Appl. No.: 16/731,596

(22) Filed: Dec. 31, 2019

(51) Int. Cl. C09D 183/00; C09D 5/08

(52) U.S. Cl. CPC C09D 183/00; C09D 5/08

(57) ABSTRACT

A method for manufacturing a water-based coating material is provided, including: (a) reacting tetraalkoxysilane, acidic aqueous solution of vanadium salt, and trialkoxyalkylsilane to form an oligomer; (b) reacting the oligomer with colloidal silica particles to form a modified oligomer; and (c) reacting the modified oligomer with trialkoxyepoxysilane to obtain a water-based coating material.

### TECHNICAL FIELD

The technical field relates to a water-based coating material, and in particular it relates to method for manufacturing the same.

### BACKGROUND

The global market for metal pretreatment/anti-corrosion coatings is about 17 million tons (4 billion US dollars), of which the Asian market accounts for about 37%. The most widely used materials include phosphate and chromate (86%), chromium-free coatings (1%), and others (13%). Currently, hexavalent chromium is the best anti-corrosion metal film treatment, but chromium-free coating has become a mainstream in new environmental protection technological development in an era of rising environmental awareness and stricter international regulations. In addition, a large amount of surfactant is added to traditional water-based coating material to improve the dispersion stability of the particles. However, the hydrophilic groups of the surfactant will absorb water to reduce the anti-corrosion ability of the coated film after drying the coating material to form the coated film.

Accordingly, a novel chromium-less, water-based, and anti-corrosion coating material is called for.

### SUMMARY

One embodiment of the disclosure provides a method for manufacturing a water-based coating material, including: (a) reacting tetraalkoxysilane, acidic aqueous solution of vanadium salt, and trialkoxyalkylsilane to form an oligomer; (b) reacting the oligomer with colloidal silica particles to form a modified oligomer; and (c) reacting the modified oligomer with trialkoxyepoxysilane to obtain a water-based coating material.

One embodiments of the disclosure provides a water-based coating material, including: a product formed by reacting a modified oligomer with trialkoxyepoxysilane, wherein the modified oligomer is formed by reacting an oligomer with colloidal silica particles, and wherein the oligomer is formed by reacting tetraalkoxysilane, acidic aqueous solution of vanadium salt, and trialkoxyalkylsilane.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a method for manufacturing a water-based coating material, including: (a) reacting tetraalkoxysilane, acidic aqueous solution of vanadium salt, and trialkoxyalkylsilane to form an oligomer; (b) reacting the oligomer with colloidal silica particles to form a modified oligomer; and (c) reacting the modified oligomer with trialkoxyepoxysilane to obtain a water-based coating material. In some embodiments, the weight ratio of the tetraalkoxysilane to the vanadium salt is from 1:0.01 to 1:0.25, such as about 1:0.01 to 1:0.05, about 1:0.05 to 1:0.10, about 1:0.10 to 1:0.15, about 1:0.15 to 1:0.20, about 1:0.20 to 1:0.25, or the like, but it is not limited thereto. If the vanadium salt ratio is too low, the electrochemical AC impedance value of the film will be lower, which means that the corrosion inhibition of the film is insufficient. If the vanadium salt ratio is too high, the pH value of the coating material will be too low to negatively influence the compactness of the film. The weight ratio of the tetraalkoxysilane to the trialkoxyalkylsilane may be from 1:0.1 to 1:3.0, such as 1:0.1 to 1:0.5, 1:0.5 to 1:1.0, 1:1.0 to 1:1.5, 1:1.5 to 1:2.0, 1:2.0 to 1:2.5, 1:2.5 to 1:3.0, or the like, but it is not limited thereto. If the trialkoxyalkylsilane ratio is too low, the oligomer will be easily gelled due to insufficient stability, and the hydrophilic corrosion elements will easily permeate into the substrate due to insufficient hydrophobicity of the film. If the trialkoxyalkylsilane ratio is too high, the oligomer will be more hydrophobic, and the coating material will be phase separated to produce suspension. In some embodiments, the weight ratio of the tetraalkoxysilane to the colloidal silica particles may be from 1:0.2 to 1:1.5, such as about 1:0.2 to 1:0.4, 1:0.4 to 1:0.5, 1:0.5 to 1:0.7, 1:0.7 to 1:0.9, 1:0.9 to 1:1.2, 1:1.2 to 1:1.3, 1:1.3 to 1:1.4, 1:1.4 to 1:1.5, or the like, but it is not limited thereto. If the colloidal silica particles ratio is too low, the compactness of the film will be insufficient. If the colloidal silica particles ratio is too high, the hydrophilicity of the film will be too high. In some embodiments, the weight ratio of the tetraalkoxysilane to the trialkoxyepoxysilane may be from 1:1.0 to 1:10.0, such as 1:1.0 to 1:2.0, 1:2.0 to 1:2.5, 1:2.5 to 1:3.0, 1:3.0 to 1:4.0, 1:4.0 to 1:5.0, 1:5.0 to 1:6.0, 1:6.0 to 1:7.0, 1:7.0 to 1:8.0, 1:8.0 to 1:9.0, 1:9.0 to 1:10.0, or the like, but it is not limited thereto. If the trialkoxyepoxysilane ratio is too low, the coating material stability will be insufficient, and the adhesion of the film and the substrate will be also insufficient. If the trialkoxyepoxysilane ratio is too high, the coating material will be phase separated to produce suspension.

In some embodiments, the tetraalkoxysilane includes tetramethoxysilane (TMOS), tetraethoxysilane (TEOS), tetrapropoxysilane (TPOS), or a combination thereof. In some embodiments, the trialkoxyalkylsilane comprises methyltrimethoxysilane, methyltriethoxysilane, polyethyleneglycol-modified trialkoxysilane, or a combination thereof. In some embodiments, the trialkoxyepoxysilane comprises (3-glycidyloxypropyl)-trimethoxysilane, (3-glycidyloxypropyl)-triethoxysilane, or a combination thereof. In the disclosure, tri-functional siloxane precursor is introduced to copolymerize with the di-functional siloxane precursor, which may form semi-linear ladder-type sol-gel silicon oxide material to achieve a better film formability.

In some embodiments, the acidic aqueous solution of vanadium salt has a pH value of 2 to 4, such as about 3, but it is not limited thereto. If the pH value of the acidic aqueous solution is too low, the acidic aqueous solution will be unstable and solid will precipitate out easily, or the compactness of the film will be negatively influenced. If the pH value of the acidic aqueous solution is too high, the coating material will have an insufficient stability. In some embodiments, the acid of the acidic aqueous solution of vanadium salt includes phosphoric acid, acetic acid, or a combination thereof. The pH value of the reaction is controlled by pH isoelectric point of the sol-gel silicon oxide material. When the pH value is low, the surface of the silicon oxide particles is hydrophilic, which is favorable to disperse the inorganic particles in aqueous solution. After the acid is volatilized during the drying process, the pH value of the sample becomes higher to promote crosslinking of the sol-gel coating film, and the surface of the coating film is recovered to electrical neutral and does not absorb water. As such, the film may achieve excellent water resistance and corrosion resistance.

In some embodiments, the colloidal silica particles have a diameter of about 10 nm to 30 nm, such as about 10 nm, 15 nm, 20 nm, 25 nm, 30 nm, or the like, but it is not limited thereto. If the colloidal silica particles are too small, the colloidal silica particles will easily aggregate and precipitate out. If the colloidal silica particles are too large, their dispersibility will be poor, the coating material made of these large particles will become turbid.

In some embodiments, auxiliary, aqueous resin, or a combination thereof are further added to the water-based coating material. The auxiliary can be a defoamer, a coalescing agent, or a combination thereof, but it is not limited thereto. The aqueous resin can be polyvinyl acetate (PVAc), acrylic, or a combination thereof, but it is not limited thereto.

Alternatively, a water-based coating material is provided, which includes a product formed by reacting a modified oligomer with trialkoxyepoxysilane, wherein the modified oligomer is formed by reacting an oligomer with colloidal silica particles, and wherein the oligomer is formed by reacting tetraalkoxysilane, acidic aqueous solution of vanadium salt, and trialkoxyalkylsilane. The water-based coating material is similar to that described above and the related description is not repeated here.

The disclosure develops a method to wrap a compound containing vanadium and oxygen by siloxane precursors of different types via sol-gel process to prepare a hybrid resin coating material, which may directly replace passivation film. The material design may have excellent film formability and metal adhesion/paint adhesion. The material chemical crosslinking design may readily utilize an equipment of traditional passivation process to do the coating, such that metal processing plants do not need to frequently replace the equipment. As such, it can speed up the introduction of new technologies, and take into account the water-based, self-dispersing cross-linking design to meet the requirements of metal passivation and corrosion resistance.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 3.09, viscosity was 2.27 cps, average diameter was 69.74 nm, and Zeta potential was −2.67 mV.

### Example 2

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 2.99, viscosity was 2.27 cps, average diameter was 69.74 nm, and Zeta potential was −2.67 mV.

### Example 3

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 3.07, viscosity was 3.36 cps, average diameter was 69.74 nm, and Zeta potential was −2.67 mV.

### Example 4

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 2.99, viscosity was 3.34 cps, average diameter was 69.74 nm, and Zeta potential was −2.67 mV.

### Example 5

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 2.87, viscosity was 3.71 cps, average diameter was 69.74 nm, and Zeta potential was −2.67 mV.

### Example 6

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 3.02, viscosity was 3.12 cps, average diameter was 69.74 nm, and Zeta potential was −2.67 mV.

### Example 7

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a water-based coating material. The reactant amounts for the water-based coating material are tabulated in Table 1. The chemical and physical properties of the water-based coating material are shown below: solid content was 17.85%, pH value was 2.96, viscosity was 3.14 cps, average diameter was 69.74 nm, and Zeta potential was −2.67 mV.

TABLE 1

| | | | | CT20DH | | | |
|---|---|---|---|---|---|---|---|
| | TEOS | A162 | A187 | dispersion | NaVO₃ | H₃PO₄ | |
| | (g) | (g) | (g) | (g) | (g) | (g) | pH |
| Example 1 | 2.145 | 5.355 | 15 | 7.5 | 0.341 | 0.260 | 3.09 |
| Example 2 | 2.145 | 5.355 | 15 | 7.5 | 0.228 | 0.174 | 2.99 |
| Example 3 | 3.750 | 3.750 | 15 | 7.5 | 0.341 | 0.260 | 3.07 |
| Example 4 | 3.750 | 3.750 | 15 | 7.5 | 0.228 | 0.174 | 2.99 |
| Example 5 | 3.750 | 3.750 | 15 | 7.5 | 0.114 | 0.087 | 2.87 |
| Example 6 | 5.355 | 2.145 | 15 | 7.5 | 0.341 | 0.260 | 3.02 |
| Example 7 | 5.355 | 2.145 | 15 | 7.5 | 0.228 | 0.174 | 2.96 |

### Comparative Example 1

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt and methyltriethoxysilane (A162) were mixed in water (without TEOS), and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a solution with suspended solids. The reactant amounts for the reaction are tabulated in Table 2.

### Comparative Example 2

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt and tetraethoxysilane (TEOS) were mixed in water (without A162), and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight, thereby obtaining a solution with suspended solids. The reactant amounts for the reaction are tabulated in Table 2.

### Comparative Example 3

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction to continuously react at room temperature overnight (without A187), thereby obtaining a solution with suspended solids. The reactant amounts for the reaction are tabulated in Table 2.

### Comparative Example 4

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, tetraethoxysilane (TEOS), and methyltriethoxysilane (A162) were mixed in water, and stirred at room temperature for 3 hours. Subsequently, (3-glycidyloxypropyl)-trimethoxysilane (A187) was then added to the reaction to continuously react at room temperature overnight (without CT20DH), thereby obtaining a solution with suspended solids. The reactant amounts for the reaction are tabulated in Table 2.

### Comparative Example 5

Aqueous solution of phosphoric acid (about 0.36 g after conversion), tetraethoxysilane (TEOS), and methyltriethoxysilane (A162) were mixed in water (without NaVO₃), and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight. The reactant amounts for the reaction are tabulated in Table 2.

### Comparative Example 6

Aqueous solution of phosphoric acid (about 0.18 g after conversion), tetraethoxysilane (TEOS), and methyltriethoxysilane (A162) were mixed in water (without NaVO₃), and stirred at room temperature for 3 hours. Subsequently, colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes. (3-glycidyloxypropyl)-trimethoxysilane (A187) was then added to the reaction to continuously react at room temperature overnight. The reactant amounts for the reaction are tabulated in Table 2.

TABLE 2

| | | | | CT20DH | | | |
|---|---|---|---|---|---|---|---|
| | TEOS | A162 | A187 | dispersion | NaVO₃ | H₃PO₄ | |
| | (g) | (g) | (g) | (g) | (g) | (g) | Remarks |
| Comparative | — | 7.5 | 15 | 7.5 | 0.341 | 0.260 | Solution |
| Example 1 | | | | | | | with |
| | | | | | | | suspended |
| | | | | | | | solids |
| Comparative | 7.5 | — | 15 | 7.5 | 0.341 | 0.260 | Solution |
| Example 2 | | | | | | | with |
| | | | | | | | suspended |
| | | | | | | | solids |
| Comparative | 2.145 | 5.355 | — | 7.5 | 0.341 | 0.260 | Solution |
| Example 3 | | | | | | | with |
| | | | | | | | suspended |
| | | | | | | | solids |
| Comparative | 2.145 | 5.355 | 15 | — | 0.341 | 0.260 | Solution |
| Example 4 | | | | | | | with |
| | | | | | | | suspended |
| | | | | | | | solids |
| Comparative | 2.145 | 5.355 | 15 | 7.5 | — | 0.360 | — |
| Example 5 | | | | | | | |
| Comparative | 2.145 | 5.355 | 15 | 7.5 | — | 0.180 | — |
| Example 6 | | | | | | | |

As seen in Table 2, the water-based coating material of vanadium salt should combine siloxane and colloidal particles to maintain excellent stability.

### Comparative Example 7

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, 2.145 g of tetraethoxysilane (TEOS), and 5.355 g of methyltriethoxysilane (A162) were mixed in water, and stirred at room temperature for 3 hours. Subsequently, 7.5 g of colloidal silica dispersion Lavasil CT30DH (commercially available from AkzoNobel, diameter=10 nm, and solid content=about 22 wt %) was added to the reaction and then continuously stirred at room temperature for 30 minutes. Then, 15 g of (3-glycidyloxypropyl)-trimethoxysilane (A187) was then added to the reaction to continuously react at room temperature overnight, thereby obtaining a solution having aggregation. Accordingly, the diameter of the colloidal particles would also influence the stability of the water-based coating material.

### Comparative Example 8

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, 2.145 g of tetraethoxysilane (TEOS), and 5.355 g of methyltriethoxysilane (A162), 7.5 g of colloidal silica dispersion Lavasil CT20DH (commercially available from AkzoNobel, diameter=20 nm, and solid content=about 34 wt % to 35 wt %), and 15 g of (3-glycidyloxypropyl)-trimethoxysilane (A187) were mixed in water to react at room temperature overnight, thereby obtaining a solution with suspended solids.

### Comparative Example 9

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, 2.145 g of tetraethoxysilane (TEOS), and 5.355 g of methyltriethoxysilane (A162) were mixed in water, and stirred at room temperature for 3 hours. Subsequently, 15 g of (3-glycidyloxypropyl)-trimethoxysilane (A187) was added to the reaction to continuously react at room temperature overnight. Then, 7.5 g of colloidal silica dispersion Lavasil CT20DH (commercially available from AkzoNobel, diameter=20 nm, and solid content=about 34 wt % to 35 wt %) was added to the reaction and then continuously stirred at room temperature for 30 minutes, thereby obtaining a solution having precipitate.

### Comparative Example 10

Aqueous solution of sodium metavanadate (NaVO₃) was adjusted by 85 wt % phosphoric acid (H₃PO₄), thereby obtaining an acidic aqueous solution of vanadium salt having a pH value of 2 to 4. The acidic aqueous solution of vanadium salt, 2.145 g of tetraethoxysilane (TEOS), and 5.355 g of methyltriethoxysilane (A162) were mixed in water, and stirred at room temperature for 3 hours. Subsequently, 7.5 g of colloidal silica dispersion Lavasil CT20DH (commercially available from AkzoNobel, diameter=20 nm, and solid content=about 34 wt % to 35 wt %) and 15 g of (3-glycidyloxypropyl)-trimethoxysilane (A187) were then added to the reaction to continuously react at room temperature overnight, thereby obtaining a suspension. Accordingly, the addition order of the reactants was beneficial to the stability of the water-based coating material.

### Example 8

The water-based coating materials in Examples 1 to 7, the water-based coating materials in Comparative Examples 5 and 6, and the aqueous solution of vanadium salt (prepared as Comparative Example 1) were respectively applied on acid-washed aluminum substrates via flow coating, and dried at 60° C. for 10 minutes and then dried at 200° C. for 10 minutes to form coating films. The acid-washed aluminum substrates that were treated with hexavalent chromium treatment (provided by Tatung) were dried at 60° C. for 10 minutes and then further dried at 200° C. for 10 minutes. Thereafter, the film impedances (Ohm·cm²) were respectively measured by electrochemical impedance spectroscopy (EIS), and the film adhesions were respectively measured by the standard ASTM D3359, as tabulated in Table 3.

TABLE 3

| | Coating | Coating |
|---|---|---|
| | EIS impedance | adhesion |
| Coating material | (Ohm · cm²) | (ASTM D3359) |
| Example 1 | 2.19*10⁶ | 5B |
| Example 2 | 3.51*10⁵ | 5B |
| Example 3 | 2.35*10⁶ | 5B |
| Example 4 | 2.02*10⁶ | 5B |
| Example 5 | 1.93*10⁶ | 5B |
| Example 6 | 9.53*10⁵ | 5B |
| Example 7 | 1.52*10⁶ | 5B |
| Comparative Example 5 | 2.29*10⁴ | 5B |
| Comparative Example 6 | 1.84*10⁵ | 5B |
| Aqueous solution of vanadium salt | 6.13*10⁵ | 5B |
| Hexavalent chromium treatment | 1.71*10⁵ | 5B |
| (Tatung) | | |

As seen in Table 3, the EIS impedance of the corrosion resistance from direct treatment of vanadium acid and phosphoric acid (Comparative Examples 5 and 6) or chromic acid was 10⁴ to 10⁵ Ohm·cm², and the EIS impedance of the film from the water-based coating material in the disclosure could achieve 10⁶ Ohm·cm².

### Example 9

The water-based coating material in Example 1 was coated on an acid-washed aluminum substrate by flow coating, and then dried at 60° C. for 10 minutes. Similarly, the acid-washed aluminum substrates that were respectively treated by hexavalent chromium treatment (provided by Tatung), BASF Gardobond®, and Henkel Alodine® were also dried at 60° C. for 10 minutes, and then further dried at 200° C. for 10 minutes. Thereafter, the coating films were tested by the standard ASTM B117 (salt spray test).

TABLE 4

| | Salt spray test | |
|---|---|---|
| Coating material | (ASTM B117) | |
| Example 1 | ~200 | hr |
| Hexavalent chromium treatment | ~160 | hr |
| (Tatung) | | |
| BASF Gardobond ® | ~72 | hr |
| Henkel Alodine ® | ~72 | hr |

As seen in Table 4, salt spray test results show that the water-based coating material had an obviously better performance than the hexavalent chromium treatment, BASF Gardobond® film, and Henkel Alodine® film.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A method for manufacturing a water-based coating material, comprising:
(a) reacting tetraalkoxysilane, acidic aqueous solution of vanadium salt, and trialkoxyalkylsilane to form an oligomer;
(b) reacting the oligomer with colloidal silica particles to form a modified oligomer; and
(c) reacting the modified oligomer with trialkoxyepoxysilane to obtain a water-based coating material.

2. The method as claimed in claim 1, wherein the weight ratio of the tetraalkoxysilane to the vanadium salt is from 1:0.01 to 1:0.25.

3. The method as claimed in claim 1, wherein the weight ratio of the tetraalkoxysilane to the trialkoxyalkylsilane is from 1:0.1 to 1:3.0.

4. The method as claimed in claim 1, wherein the weight ratio of the tetraalkoxysilane to the colloidal silica particles is from 1:0.2 to 1:1.5.

5. The method as claimed in claim 1, wherein the weight ratio of the tetraalkoxysilane to the trialkoxyepoxysilane is from 1:1.0 to 1:10.0.

6. The method as claimed in claim 1, wherein the tetraalkoxysilane comprises tetramethoxysilane, tetraethoxysilane, tetrapropoxysilane, or a combination thereof.

7. The method as claimed in claim 1, wherein the trialkoxyalkylsilane comprises methyltrimethoxysilane, methyltriethoxysilane, polyethyleneglycol-modified trialkoxysilane, or a combination thereof.

8. The method as claimed in claim 1, wherein the trialkoxyepoxysilane comprises (3-glycidyloxypropyl)-trimethoxysilane, (3-glycidyloxypropyl)-triethoxysilane, or a combination thereof.

9. The method as claimed in claim 1, wherein the acidic aqueous solution of vanadium salt has a pH value of 2 to 4.

10. The method as claimed in claim 1, wherein the colloidal silica particles have a diameter of 10 nm to 30 nm.

11. A water-based coating material, comprising:
a product formed by reacting a modified oligomer with trialkoxyepoxysilane,
wherein the modified oligomer is formed by reacting an oligomer with colloidal silica particles, and
wherein the oligomer is formed by reacting tetraalkoxysilane, acidic aqueous solution of vanadium salt, and trialkoxyalkylsilane.

12. The water-based coating material as claimed in claim 11, wherein the weight ratio of the tetraalkoxysilane to the vanadium salt is from 1:0.01 to 1:0.25.

13. The water-based coating material as claimed in claim 11, wherein the weight ratio of the tetraalkoxysilane to the trialkoxyalkylsilane is from 1:0.1 to 1:3.0.

14. The water-based coating material as claimed in claim 11, wherein the weight ratio of the tetraalkoxysilane to the colloidal silica particles is from 1:0.2 to 1:1.5.

15. The water-based coating material as claimed in claim 11, wherein the weight ratio of the tetraalkoxysilane to the trialkoxyepoxysilane is from 1:1.0 to 1:10.0.

16. The water-based coating material as claimed in claim 11, wherein the tetraalkoxysilane comprises tetramethoxysilane, tetraethoxysilane, tetrapropoxysilane, or a combination thereof.

17. The water-based coating material as claimed in claim 11, wherein the trialkoxyalkylsilane comprises methyltrimethoxysilane, methyltriethoxysilane, polyethyleneglycol-modified trialkoxysilane, or a combination thereof.

18. The water-based coating material as claimed in claim 11, wherein the trialkoxyepoxysilane comprises (3-glycidyloxypropyl)-trimethoxysilane, (3-glycidyloxypropyl)-triethoxysilane, or a combination thereof.

19. The water-based coating material as claimed in claim 11, wherein the acidic aqueous solution of vanadium salt has a pH value of 2 to 4.

20. The water-based coating material as claimed in claim 11, wherein the colloidal silica particles have a diameter of 10 nm to 30 nm.
